(19) United States
(12) Patent Application Publication
(10) Pub. No.: US 2024/0114877 A1
(43) Pub. Date: Apr. 11, 2024

(54) LEAF-BASED COMPOSITION AND METHOD FOR PET BIOWASTE

(71) Applicant: Damaria Walker, Detroit, MI (US)

(72) Inventor: Damaria Walker, Detroit, MI (US)

(21) Appl. No.: 18/045,456

(22) Filed: Oct. 10, 2022

(51) Int. Cl. A01K 1/015

(52) U.S. Cl. CPC A01K 1/0155

(57) ABSTRACT

A leaf-based system and method may be configured for pet biowaste treatment. This may include collecting a leaf-based material in a container, adding fluid to the leaf-based material, soaking the leaf-based material in the fluid, straining excess fluid from the leaf-based material, combining the leaf-based material, an alkaline agent, and a drying agent to form a leaf-based alkaline-desiccant mixture, drying the leaf-based alkaline-desiccant mixture, and baking the leaf-based alkaline-desiccant mixture.

### BACKGROUND

The global market for cat litter products is valued at over nine billion dollars and continued growth is expected for at least the next decade. An increasing number of cat owners across the globe is expected to positively impact market growth. Price, material, and functionality are the key factors influencing decisions made by consumers in choosing cat litter. Additionally, rising demand for technology advancements in litter boxes can also influence purchases.

Traditional solutions are expensive and ineffective. For example, traditional solutions do not fully absorb biowaste (e.g., feces of animals such as cats). Typical pet litter products do not fully absorb biowaste and require continued replenishment of product. This results in product waste, unnecessary work, and increased costs. Traditional products offer inadequate deodorizing agents and fail to limit product and associated dust from escaping the litter box.

There is a need for solutions to the above problems according to the embodiments disclosed herein. This disclosure includes an innovative system, composition, and method utilizing leaf-based, recyclable, discardable, and/or natural materials for biowaste management. Embodiments may include or utilize one or more leaves (e.g., curried, fermented, and/or tobacco), alkaline agents (e.g., baking soda), drying agents (e.g., desiccant such as silica gel), water-soluble agents (e.g., detergent), or a combination thereof. This disclosure provides improved absorption, deodorization, and containment of products and associated dust.

### BRIEF DESCRIPTION OF THE DRAWINGS

The following brief description of the embodiments is set forth with reference to the accompanying drawings:

FIG. 1 is a front view of an embodiment of the present disclosure, for example, for collecting leaf-based material;

FIG. 2 is a front view of an embodiment of the present disclosure, e.g., for rinsing, soaking, and straining leaf-based material;

FIG. 3 is a front view of an embodiment of the present disclosure, e.g., for mixing leaf-based material with agents;

FIG. 4 is a front view of an embodiment of the present disclosure, e.g., for baking leaf-based material;

FIG. 5 is a front view of an embodiment of the present disclosure, e.g., a packaging system;

FIG. 6 is a front view of an embodiment of the present disclosure, e.g., dedicated compartments of a packaging system;

FIG. 7 is a front view of an embodiment of the present disclosure, e.g., another packaging system;

FIG. 8 is a front view of an embodiment of the present disclosure, e.g., another packaging system;

FIG. 9 is a front view of an embodiment of the present disclosure, e.g., another packaging system;

FIG. 10 is a front view of an embodiment of the present disclosure, e.g., another packaging system;

FIG. 11 is a closer view of an embodiment of the present disclosure, e.g., an upper portion of a packaging system;

FIG. 12 is a cross-section view of an embodiment of the present disclosure, e.g., a packaging system having dedicated compartments; and

FIG. 13 is an exploded view of another embodiment of the present disclosure, e.g., a packaging system having dedicated compartments.

### DETAILED DESCRIPTION

Embodiments provide improvements and advantages including efficient and cost-effective handling of biowaste. This provides a cat litter product that provide reduced odor and free, increased absorption, and less tracking out of the cat litter box. An improved cat litter is provided and includes recycled tobacco retained from tobacco manufacturer surplus. The recycled tobacco is expended in a systematic process in which cat litter is produced.

A leaf-based system and method may be configured for pet biowaste treatment. This may include collecting a leaf-based material in a container, adding a fluid to the leaf-based material, soaking the leaf-based material in the fluid, straining excess fluid from the leaf-based material, combining the leaf-based material, an alkaline agent, and a drying agent to form a leaf-based alkaline-desiccant mixture, drying the leaf-based alkaline-desiccant mixture, and baking the leaf-based alkaline-desiccant mixture.

Embodiments may include providing the leaf-based material including natural tobacco and the container having a plurality of apertures. This may include repeating the soaking and straining steps until the leaf-based material has a lighter color, air drying the leaf-based alkaline-desiccant mixture on an open surface, providing packaging having respective compartments for each of the leaf-based material, alkaline agent, and drying agent, and providing the container having at least one of a closure, a viewing window, and a disposal indictor.

The composition may be made from recyclable tobacco. This may include collecting natural leaf tobacco, soaking it in a bag having hot water, and adding baking soda. This may further include mixing the natural leaf tobacco thoroughly, adding detergent into the mixture, pouring the tobacco out of the bag for drying, adding baking soda, adding a drying agent, and straining tobacco over a basin. Advantages include improved absorption, reduction of dust free, less tracking out of a cat litter box, and extended deodorization.

This disclosure provides a system, composition, and an improved method for optimized utilization of bioabsorbable material. This includes an improved bioabsorbable leaf-based composition. An exemplary composition may include and/or utilize natural leaf, tobacco, Nicotiana tabacum silica, gel, soap, sodium hydrogen carbonate, sodium laureth sulfate, and/or sodium lauryl sulfate. Any or all of these could be natural, leaf-based, tobacco-based, Nicotiana tabacum-based, and/or recyclable tobacco collected from a manufacturing surplus.

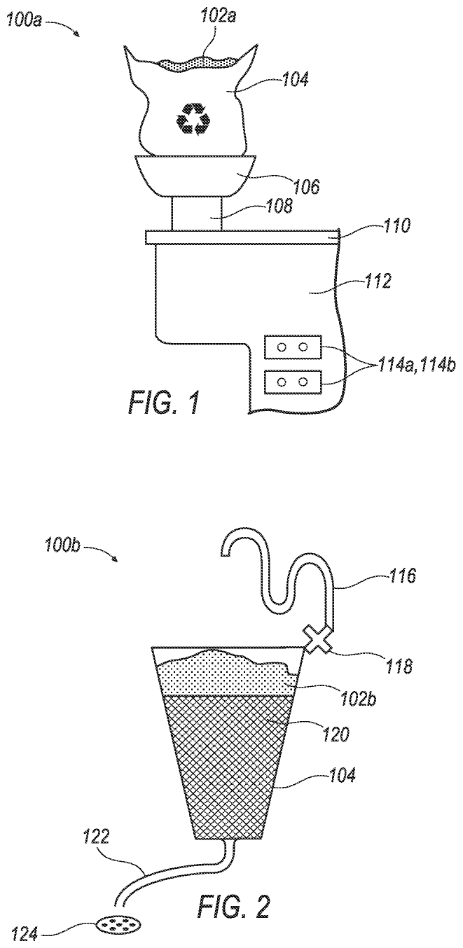

FIGS. 1-12 illustrate embodiments of systems 100, 200 and are intended to be illustrative and not restrictive. Any portion of the systems, methods, and processes herein may occur in any arrangement, order, or sequence. Certain components or steps may occur simultaneously, others may be added, and/or others may be omitted. This disclosure is provided for the purpose of illustrating certain embodiments and should in no way be construed to limit the claims.

FIG. 1 illustrates an embodiment of system 100, e.g., system 101a for collecting leaf-based materials. System 100 may include any or all of leaf-based material 102 (e.g., 102a), container 104, scale 106, pedestal 108, support surface 110, housing 112, and sources 114a,b (e.g., fluid and/or power). Leaf-based material 102 may include natural leaf tobacco. Leaf-based material 102 may be recycled from natural leaf tobacco companies or products.

Container 104 may be configured to receive and soak, heat, and/or strain leaf-based material 102. Container 104 may include one or more apertures having a closed condition to retain water and soak leaf-based material 102 and an open condition drain fluid from leaf-based material 102. Container 104 may receive fluid (e.g., water) and leaf-based material 102.

FIG. 2 illustrates an embodiment of system 100, e.g., system 100b for straining leaf-based materials. System 100 may include one or more leaf-based material 102 (e.g., 102b), supply line 116, flow adjustment 118, fluid 120, container 104 (e.g., mesh), drain line 122, and strainer 124. Fluid 120 may include water (e.g., H₂O) and baking soda (e.g., NaHCO₃) System 100 may be configured to strain liquids from and accelerate the drying of leaf-based material 102.

System 100 may apply fluid 102 to leaf-based material 102 thereby cleaning, purifying, and reducing the odor of leaf-based material 102. Supply line 116 may direct fluid to leaf-based material 102 and into container 104 thereby rinsing leaf-based material 102. Container 104 may include one or more apertures for ventilation of leaf-based material 102 and drainage of excess water. Leaf-based material 102 may be rinsed until the fluid becomes clear or light brown. Excess fluid 120 may be strained from leaf-based material 102 and removed via drain 124.

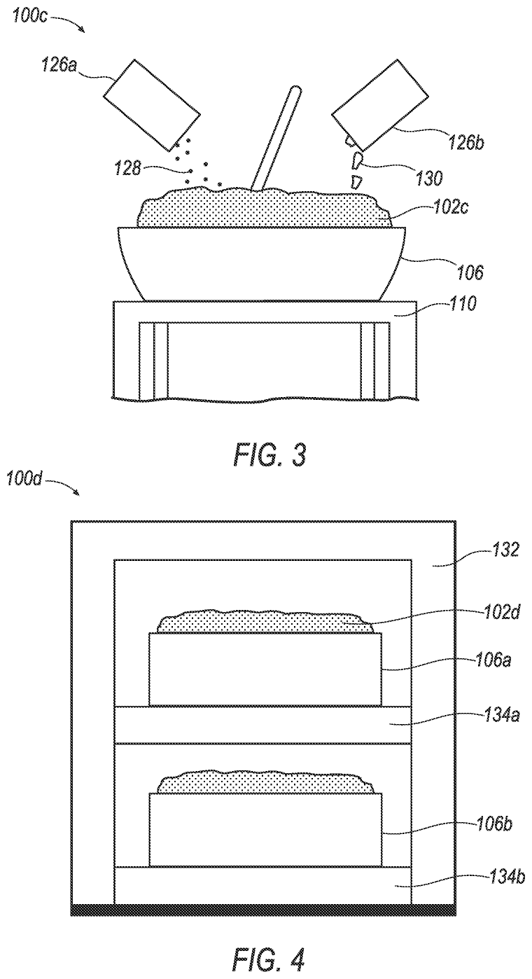

FIG. 3 illustrates an embodiment of system 100, e.g., system 100c for mixing of leaf-based material. System 100 may include any or all of leaf-based material 102 (e.g., 102c), dispensers 126a, 126b, hygroscopic agent 128 (e.g., silica gel), alkaline agent 130 (e.g., baking soda), basin 106, and table 110. Hygroscopic agent 128 and/or alkaline agent 130 may be added to and mixed with leaf-based material 102. Alkaline agent 130 may be added to and deodorize leaf-based material 102. Alkaline agent 130 may be added while fluid source 116 directs fluid to rinse leaf-based material 102.

Basin 106 and/or table 110 may be used to dry leaf-based material 102. The leaf-based material 102 may be air-dried for a few days. Alkaline agent 130 may be added to the leaf-based material 102. Hygroscopic 128 may be added for absorption of biowaste and acts as an anti-odor agent.

Leaf-based material 102 may be poured out and dried on a flat surface, e.g., for one or more hours or days. Hygroscopic agent 128 and alkaline agent 130 may be added to leaf-based material 102. Alkaline agent 130 is used to induce or sustain a state of dryness. Alkaline agent 130, may include silica gel, desiccant, odor-absorbing packets, oxygen-absorbent packets, drying beads, hygroscopic drying property, and/or oxygen depriving property.

Leaf-based material 102 may be placed in basin 116 to thoroughly clean the leaf-based material 102 (e.g., natural leaf tobacco) until the excess of the leaf-based material 102 or residue thereof has been removed. A stirrer may be used to mix and add alkaline agent 130, dish soap, or a combination thereof in basin 116. Alkaline agent 130 may be utilized as a natural refresher and anti-odor agent.

FIG. 4 illustrates an embodiment of system 100, e.g., system 100d for baking leaf-based material 102. System 100 may include housing 132 and shelves 134a, 134b to receive one or more basins 106a, 106b.

FIG. 4 illustrates system 100d for baking. System 100 may include oven 132 having shelves 134a, 134b. Shelves 134a, 134b may be configured to receive pans 106a, 106b. Oven 132 may heat and dry leaf-based material 102 (e.g., 102d). Oven 132 may heat leaf-based material 102 until it is thoroughly dry, e.g., at around 250-275° F. for about 3 hours.

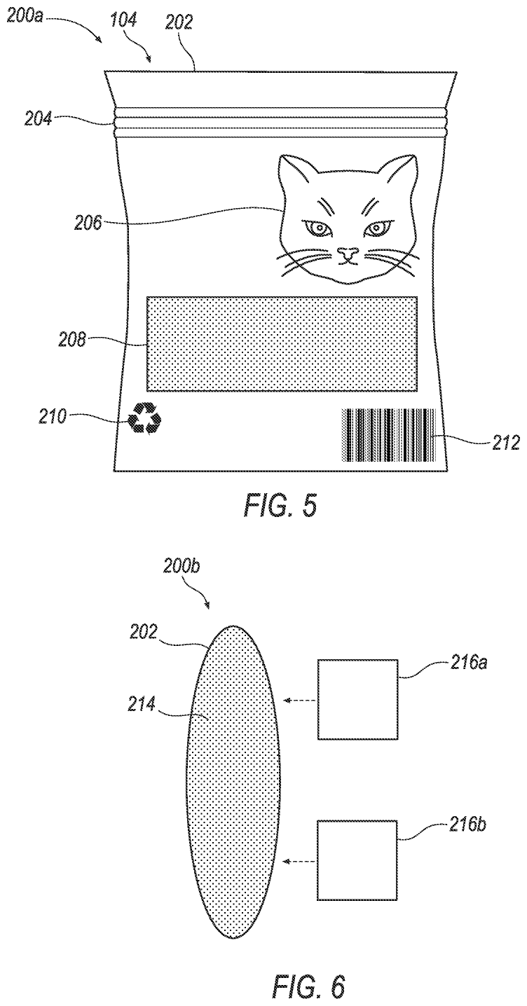

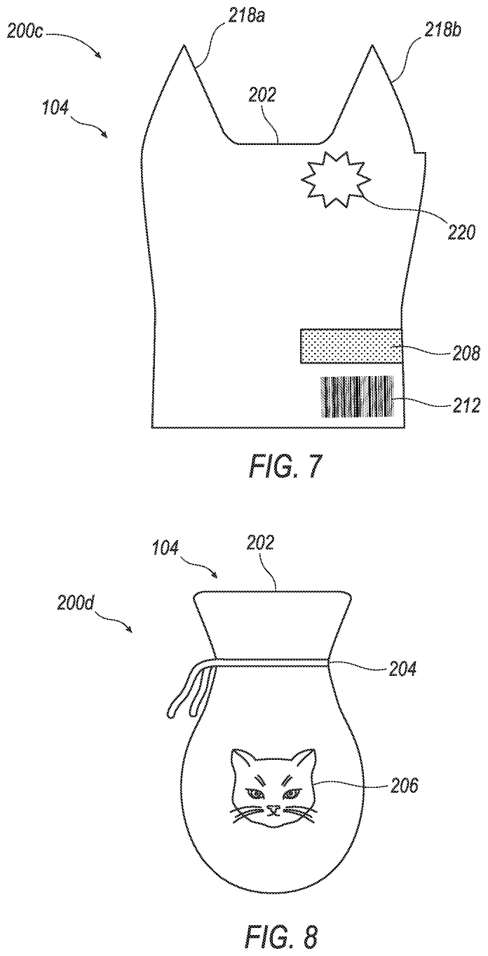

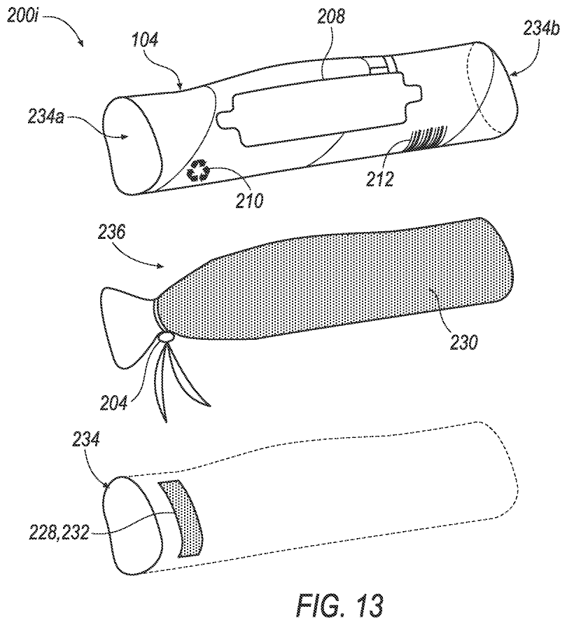

FIGS. 5-13 illustrate system 200 (e.g., systems 200a-i) for packaging leaf-based material 102. System 200 may include container 104, e.g., stand-up container 202. Container 202 may include a resealable pouch (FIG. 5), gable box (FIG. 7), drawstring sack (FIG. 8), and packaging tube (FIG. 13) or a combination thereof such as a drawstring sack receivable in a gable box. Leaf-based material 102 may be added into, contained, and sealed in container 202.

With further reference to FIG. 5, container 104 may include closure 204 (e.g., resealable, tamperproof, and/or lockable), pet image 206, viewing window 208, disposal indicator 210 (e.g., recycling specifications), and product identifier 212 (e.g., human or machine-readable code such as a bar code). As shown in FIG. 6, container 202 may include cavity 114 having dedicated compartments 216, e.g., an alkaline compartment 216a and a desiccant compartment 216b.

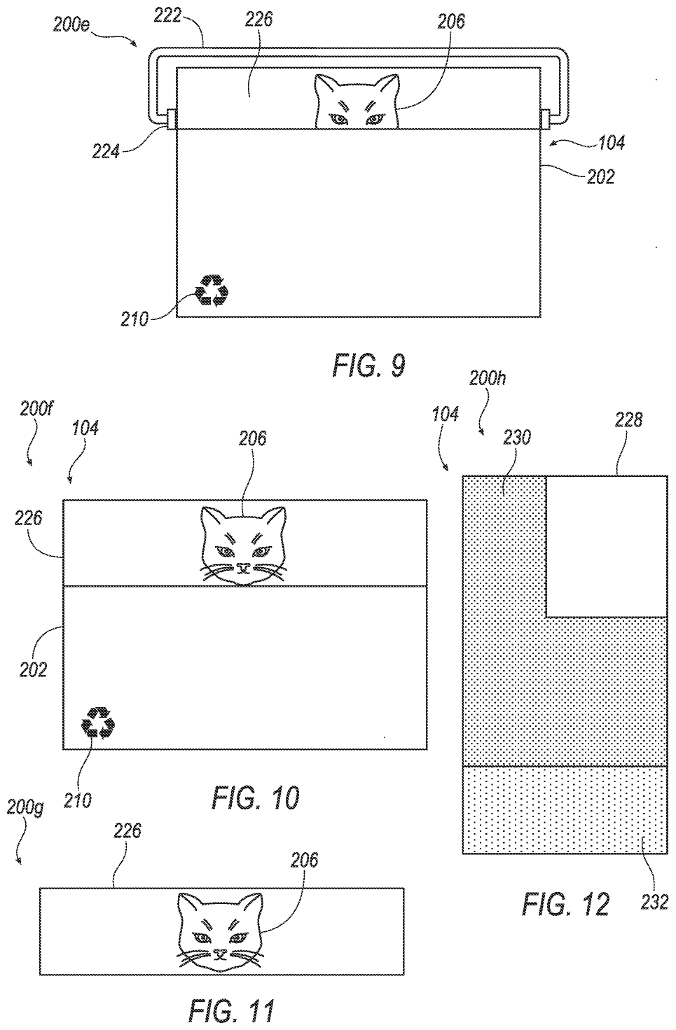

Referring to FIGS. 9-12, system 200 may include container 202, pet image 206, material indicator 210, handle 222, pivot 224, and top 226. As shown in FIG. 12, system 200 may include multiple compartments including alkaline agent compartment 228, leaf-based compartment 230, and desiccant compartment 232.

As shown in FIG. 13, system 200 may include container 104 configured as a tube and having multiple internal compartments including alkaline agent compartment 228, leaf-based compartment 230, desiccant compartment 232, or a combination thereof. Container 104 may include end caps 234a, 234b. Container 104 may be configured to receive internal sack 236, e.g., leaf-based compartment 230. Container 104 may also include alkaline agent compartment 228 and/or desiccant compartment 232 adjacent to or as part of end caps 234a, 234b

Leaf-based material 102 may be configured to decompose, degrade and/or deodorize unwanted biomaterials. Leaf-based material 102 may include a natural alkaline agent to absorb strong odors. Leaf-based material 102 may include nitrogen-based materials. Leaf-based material 102 may be configured to enhance decomposition by feeding microorganisms that break down organic materials. For example, leaf-based material 102 may include tobacco leaves, coffee grounds, or a combination thereof.

Any exemplary method may include making and/or using leaf-based material 102. The method may include removing one or more individual leaves from a live or growing plant. The method may include placing the leaves in one or more container for soaking, heating, and/or straining.

The method may include curing the leaves by drawing out and removing excess moisture from the leaves. Curing may include air, sun, heat, fire, and/or flue-curing. This may include oxidizing the leaves for a pre-defined period of time and/or degrading carotenoids in the leaves to enhance (e.g., sweetens) the fragrance and fragrance of the leaves.

The method may include fermenting the cured leaves by increasing microorganism activity to improve flavor. The method may include extracting energy from carbohydrates for a pre-defined time period. The method may include removing oxygen via suction or nitrogen flushing to release chemicals such as tar and nicotine. The method may include collecting the fermented and cured leaves and placing the leaves in a container.

Many embodiments and applications other than the examples provided are apparent upon reading the description. The scope should be determined, not with reference to the above description, but should instead be determined with reference to the claims, along with the full scope of equivalents to which such claims are entitled. Future developments will occur in the methods discussed herein, and the disclosed systems and methods will be incorporated into such future embodiments. The embodiments of this disclosure are capable of modification, variation, and adaptation.

What is claimed is:

1. A leaf-based method for pet biowaste, comprising:
collecting a leaf-based material in a container;
adding a fluid to the leaf-based material;
soaking the leaf-based material in the fluid;
straining excess fluid from the leaf-based material;
combining the leaf-based material, an alkaline agent, and a drying agent to form a leaf-based alkaline-desiccant mixture;
drying the leaf-based alkaline-desiccant mixture; and
baking the leaf-based alkaline-desiccant mixture.

2. The method of claim 1, wherein the leaf-based material includes tobacco.

3. The method of claim 1, wherein the container includes a plurality of apertures.

4. The method of claim 1, further comprising repeating the soaking and straining steps until the leaf-based material has a lighter color.

5. The method of claim 1, wherein the drying step includes air drying on an open surface.

6. The method of claim 1, further comprising providing packaging having respective compartments for each of the leaf-based material, alkaline agent, and drying agent.

7. The method of claim 1, wherein the container includes at least one of a closure, a viewing window, and a disposal indictor.

8. A leaf-based method for pet biowaste, comprising:
soaking the leaf-based material in hot fluid;
straining excess fluid from the leaf-based material;
combining the leaf-based material, an alkaline agent, and a drying agent to form a leaf-based alkaline-desiccant mixture;
drying the leaf-based alkaline-desiccant mixture; and
baking the leaf-based alkaline-desiccant mixture.

9. The method of claim 8, wherein the leaf-based material includes tobacco.

10. The method of claim 8, wherein the container includes a plurality of apertures.

11. The method of claim 8, further comprising repeating the soaking and straining steps until the leaf-based material has a lighter color.

12. The method of claim 8, wherein the drying step includes air drying on an open surface.

13. The method of claim 8, further comprising providing packaging having respective compartments for each of the leaf-based material, alkaline agent, and drying agent.

14. The method of claim 8, wherein the container includes at least one of a closure, a viewing window, and a disposal indictor.

15. A leaf-based method for pet biowaste, comprising:
combining the leaf-based material, an alkaline agent, and a drying agent to form a leaf-based alkaline-desiccant mixture;
drying the leaf-based alkaline-desiccant mixture; and
baking the leaf-based alkaline-desiccant mixture.

16. The method of claim 15, wherein the leaf-based material includes tobacco.

17. The method of claim 15, wherein the container includes a plurality of apertures.

18. The method of claim 15, further comprising repeating the soaking and straining steps until the leaf-based material has a lighter color.

19. The method of claim 15, wherein the drying step includes air drying on an open surface.

20. The method of claim 15, further comprising providing packaging having respective compartments for each of the leaf-based material, alkaline agent, and drying agent.
